(19) United States
(12) Patent Application Publication
(10) Pub. No.: US 2012/0179588 A1
(43) Pub. Date: Jul. 12, 2012

(54) METHOD AND APPARATUS FOR QUANTAL BILLING OF DIGITAL PRODUCTS

(76) Inventor: Howard Gutowitz, New York, NY (US)

(21) Appl. No.: 13/348,138

(22) Filed: Jan. 11, 2012

Related U.S. Application Data
(60) Provisional application No. 61/431,923, filed on Jan. 12, 2011.

(51) Int. Cl. G06Q 20/14

(52) U.S. Cl. 705/34

(57) ABSTRACT

A method and apparatus for quantal billing of digital products are presented. An astonishing and subtle aspect of this invention is that it permits initially free distribution of digital products with no limitation of features, and in such a way to not rush a user into trying a product before some time limit, but rather rewards the user for quick and extensive evaluation, a behavior likely to lead to eventual sales. In one aspect, it breaks the heretofore insoluble paradox of making money from initially free goods by a counter-intuitive link between per-usage and per-time period payments, whereby the user is gently transitioned from a free trial to a source of recurring revenue.

This Application claims priority to U.S. application Ser. No. 61/431,923, filed on Jan. 12, 2011. This application is incorporated herein by reference in its entirety.

### BACKGROUND OF THE INVENTION

Finding the proper mechanism for billing of digital products is a key problem of modern industry. In order to build a base of users, manufacturers of digital products often attempt initially free distribution of the product—no payment required. However, advertising aside, no profit can be made on a perpetually totally free product, and the transition from free to paid is usually perilous at best for the manufacturer of a digital product or supplier of a digital service. All of the existing methods for making that transition have serious drawbacks and profound limitation.

For example, consider the popular “freemium” method, in which the product with a limited set of features is offered for free, but the same product with some additional “premium” features activated must be paid for. The hope being that users will be so happy with the free features, that they will also want the premium features and will be willing to pay for them. One of the drawbacks of the freemium mechanism is that even users who depend on the product and use it heavily may find that the free features are good enough them, and they may never upgrade to premium. Further, is very difficult to impossible for the creator of the digital product or service to know which features should be offered for free and which should be reserved for premium, in order to maximize revenue from sale of the product or service. Similarly, so-called “nagware” offers a certain amount of time of full-featured use for free, and then begins to “nag” the user about paying, where “nagging” may consist of, for example of forcing the user of the free version to wait for a timer to time out before each use the software, or to receive annoying messages etc. Nagware is somewhat opposite of freemium in the senses that a digital product offered under the freemium model is initially crippled, but becomes uncrippled upon payment, while nagware, by contrast, becomes crippled after a certain amount of time or usage, unless there is payment. Finally, advertising, the traditional way of supporting free products, is simply inappropriate for many kinds of digital products, for example for digital products targeted at a small specialty audience, advertising cannot realistically lead to profit. Many digital product developers, in desperation, offer their work for free and simply beg for donations, relying on the good will and kindness of their users, since no existing digital-product billing mechanism will serve their purpose.

### BRIEF SUMMARY OF THE INVENTION

Among many other features and advantages, the present invention eliminates the need for the manufacturer or developer of a digital product to determine in advance how much and in what way users will use their product, and to develop a billing plan according to that hypothesis. In one aspect, it breaks the heretofore insoluble paradox of making money from initially free goods by a counter-intuitive link between per-usage and per-time period payments.

In one embodiment, it allows digital products to be offered initially for free, while transitioning seamlessly to payments sharing some, but not all, of the characteristics of a subscription, and some, but not all, of the characteristics of per-use billing. That embodiment thus provides the single advantage of the “freemium” model, the ability to entice usage by offering functionality for free, but eliminates all of its drawbacks, notably initially limited functionality, and the aforementioned need to determine in advance which features to deem “premium”. It does not nag or beg users for payment, or require developers to set up relationships with advertisers or annoy their users with advertisements. It does not hurry the trial user who wishes to take time evaluating the product, or allow avid trial users to abuse a trial without payment. Further aspects and features of the present invention will be pointed out below, in reference to various embodiments.

### BRIEF DESCRIPTION OF THE FIGURES

Various illustrative embodiments of the present invention will be presented below to particularly point out features and aspects of the present invention and to teach those skilled in the art to make and use the invention. These embodiments are for non-limiting illustrative purposes, and will be described in relation to the following Figures:

FIG. 1 An overview of aspects of the invention.

FIG. 2 A first embodiment comprising a two-part billing good, in which billing is only required when both the limit of the use-limited part and the limit of the time-limited part are exceeded.

FIG. 3 A second embodiment comprising a two-part billing good, in which billing is only required when either of the limits of the use-limited part or the time-limited part is exceeded.

FIG. 4 A third embodiment with multiple billing parts, and features generating billable quanta at different rates.

FIG. 5 A fourth embodiment in which the billing good is physically embodied at least in part.

### DETAILED DESCRIPTION

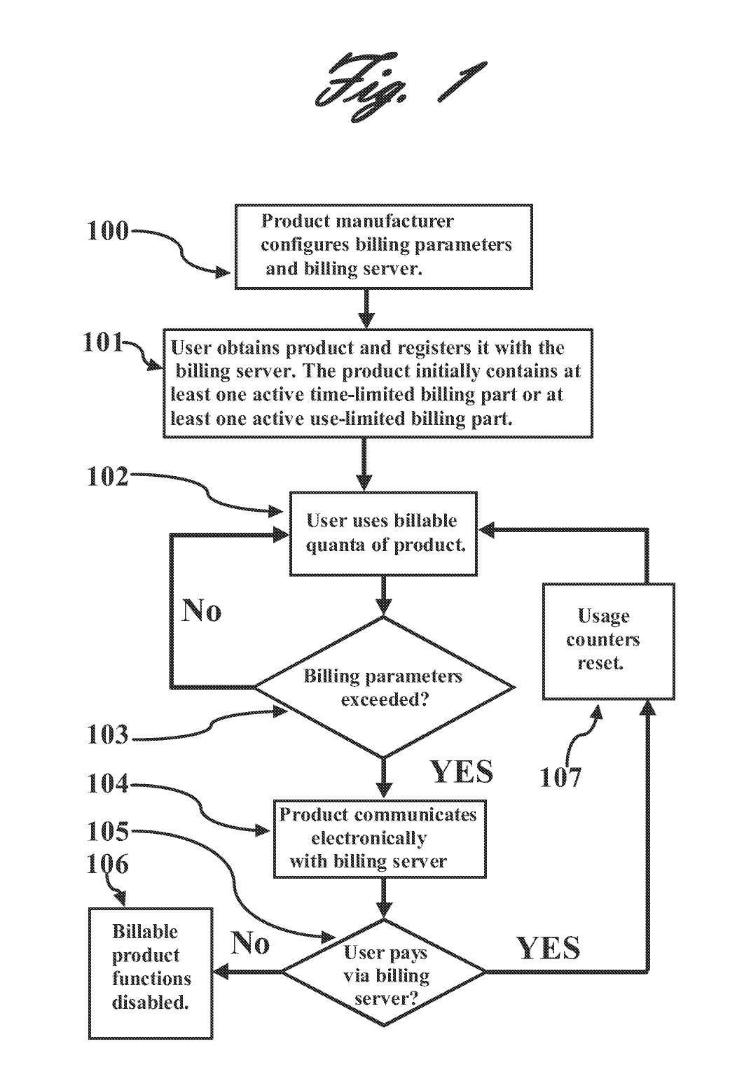

Turning now to FIG. 1, we see an overview of some aspects of the invention in operation, described in detail a flow chart pointing out how these aspects are used. At step 100, the manufacturer of a digital product sets up the billing parameters, which billing parameters will be described more fully below. The manufacturer configures a billing server with these parameters, and any other information needed to obtain and process payments from users, and record product usage quanta. At step 101, the user of the product obtains a unit of the product, and registers the product with the billing server. The initial payment, if any, is made at this point. The registration step, depending on the embodiment, may be delayed until payment is actually required of the user (see step 105). In either case, the digital product is associated to a (at least) two-part billing good, with a use-limited part and a time-limited part, a mechanism for measuring quanta of billable use, and a mechanism for communicating a measure of those quanta to the billing server, as required. At step 102, the user uses the product, causes the mechanism for measuring billing quanta to record billable usage. A further mechanism, which may be associated to the digital product itself, or to the billing server, or both, computes a pre-determined function of the billing parameters and actual billable usage, to determine if payment is required for the user to be able to continue to generate billable quanta. Examples of said pre-determined function will be described in detail in the context of various embodiments to be described below. At step 103, this further mechanism determines if payment is now required of the user since the usage has exceeded the limits incorporated in the pre-set billing parameters. If payment is required, the digital product communicates with the billing server to begin the process of obtaining payment from the user (step 104). If the user declines to pay (at step 105), the functions generating billable quanta within the digital product remain or become disabled (step 106). If the user does pay at step 105, then, at step 107, the usage counters are reset to account for that payment, and the process continues to step 102 at which the user may generate billable quanta of usage. A first embodiment comprising a two-part billing good, in which billing is only required when both the limit of the use-limited part and the limit of the time-limited part are exceeded.

This first embodiment comprises a two-part billing good, in which billing is only required if both the limit of the use-limited part and the limit of the time-limited part are exceeded. The time-limited part has a time limit, T. Time could be measured, for example, from the time that the use-limited part is purchased, or from the time the first billable use is made of the product, or some other definite time. The product itself could be e.g. an application for or part of a smart phone, or some other machine. The use-limited part allows for U billable uses. In this embodiment, we will allow the use-limited part of the billing good to be purchasable, while the time-limited part is gifted. That is, from the user's perspective, when the use limit U is exceeded before the time limit T has expired, it appears as if further use until the time T is a gift in compensation for active use of the product.

In view of the drawbacks of the prior art, such as the freemium payment apparatus, an astonishing and subtle aspect of this embodiment is that it permits initially free distribution, with no limitation of features, and yet the user is not rushed to try to product, but rather rewarded for quick evaluation by an extension of the trial to the time T when U uses are made before the time T. This behavior can be accomplished by setting the initial price billing parameter, P₀, equal to 0.

Note that with this parameter value, it is possible that communication with the billing server can be delayed until the user actually needs to buy a new use-limited part, further reducing the initial barrier the user must scale to evaluate the product. If the evaluation is unfavorable, such that the user does not wish to continue use beyond the trial, then the billing server never needs to be contacted for that user.

Note carefully that even though there is a time limit, the user can take as long as they like to evaluate the product, since payment is not required at any time that the usage u is less than U.

Note also that not all quanta of use of the product need be billable quanta for the purposes of the present billing mechanism. For example, in a product for maintaining a to-do list, the entry of an item to do may be free, but the setting of a due date for the item could be billable. Further variations within the scope of these teachings will be described in reference to other embodiments below.

Summarizing, what is taught in the present disclosure is an apparatus for quantal billing of a digital product comprising

a) a billing server,
b) a digital product distribution mechanism which distributes units of said digital product to end users along with an associated
c) billing product, said billing product comprising

i) a usage counter, counting predefined quanta of usage, u, of said digital product, said quanta of usage accumulating when predefined billable functions of said digital product are used,

ii) a time counter, counting time, t, since a predefined event at t=0, and

iii) a mechanism to communicate with said billing server to negotiate billing in the event that said usage count u exceeds a predefined usage limit U, U>0, and/or said time count t exceeds a predefined time limit T, T>0, such that either or both of said usage count u and said time count t are reset to be less than said usage limit U and said time limit T respectively when billing is successfully negotiated, and said billable functions of said digital product are disabled otherwise.

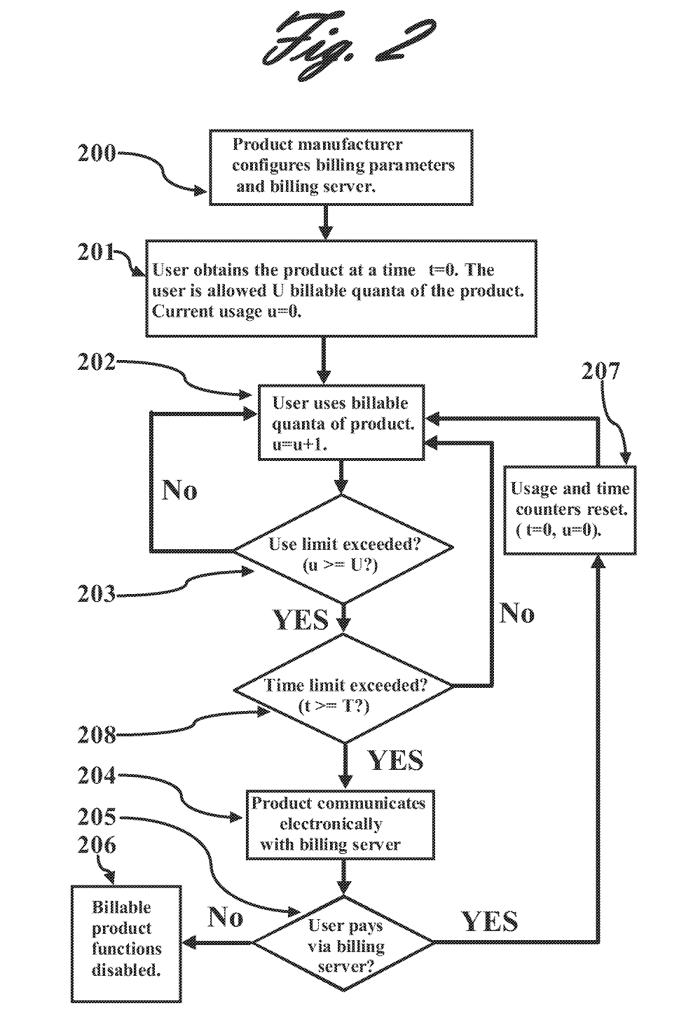

Turning now to FIG. 2, we see how this first embodiment can be used. At step 200, the product manufacturer (or their agent) configures the billing parameters. These values can be instantiated as required in the product itself and/or at the billing server, a computer designed to handle the required billing transactions. For the illustrative sake of this figure, the manufacturer chooses to set a) the time from which T is measured to be the time of the last purchase of a use-limited part, or, initially, the time the user first obtains the product, b) T, the time limit, to be a fixed time interval from the (resettable) initial time, c) the initial price is set to 0, which for illustrative purposes is configured in the product itself, not necessarily at the billing server; the initial step of contacting the billing server is not necessary in this case, d) the use limit U, denominated in billable quanta, e) the set of user actions (“uses”) which generate billable quanta, and the number of use quanta generated by each of those billable uses (in general, not all billable actions need generate the same number of quanta, but for illustrative sake in FIG. 2, all billable uses generate one quantum each), and f) an auto-renew feature set by default to on, but resettable by the user. Again, for illustration, the feature of auto-renew in this embodiment allows the user to avoid taking explicit actions to continue using the product, even when billing is required; the billing is handled as automatically as possible, whereas when auto-renew is off, explicit permission from the user is required in order to bill.

At step 201, the user obtains the product, so that T is set to 0, and the current usage counter, u, is also set to 0. At step 202, the user begins using the product. At each billable use, the usage counter is incremented. At step 203, a check is performed to compare the current usage, u, to the use limit, U. If u is greater than or equal to U, then the apparatus proceeds to step 208, otherwise, the user is free to continue generating billable quanta at step 202. At step 208, the current time t, is compared to the time limit time T. If the time is less than T, then the user is free to continue using the product to generate billable quanta, even though the use limit, U, is exceeded. Optionally, the first time step 208 and step 202 is returned to directly, the user can be notified that they have been gifted further usage, until the time T. This notice can be repeated subsequent to each purchase, when the required conditions (u>=U and t<T) are obtained. If the time limit T is also exceeded at step 208, then, at step 204, the product communicates with the billing server to get payment from the user. Payment itself might be obtained by a credit card reader or some other mechanism. If, at step 205, the user agrees to payment (either explicitly at that time, or by pre-approval if auto-renew is on) then both the use counter u, and the time count t are reset to 0, and the user may continue to use billable features of the product. If the user declines payment then, at step 206, the billable features of the product are disabled. Note carefully that in this embodiment, when the user pays (at step 205), they are paying for the use counter u to be reset to 0. The time counter, t, is set to 0 by virtue of the billing parameters having been set so that time is measured from the time of last payment for a use-limited part. In this embodiment, adjustment of time in the time-limited part is not purchasable. Time adjustment is, in effect, gifted. In other embodiments, the adjustment of the time counter could be paid, and resetting of the use counter gifted, or both paid separately.

Various further modifications to this embodiment may be made within these teachings, such as setting the initial price different from 0, or making the time limit of the time-limited part be dependent also on usage.

A second embodiment comprising a two-part billing good, in which billing is only required when either of the limits of the use-limited part or the time-limited part is exceeded, and either use-limited or time-limited part may be purchased.

To illustrate the behavior of another potential relationship between use-limited and time-limited parts of the billing good, we now consider a second embodiment in which billing is required if either of the use limit U or the time limit T are exceeded. In the first embodiment, both limits were met or exceeded before billing was required. For didactic, non-limiting purposes, only to simplify the present detailed description, we will leave the billing parameters the same as in the first embodiment described above, apart from the condition that both use-limited and time-limited parts may be purchased separately.

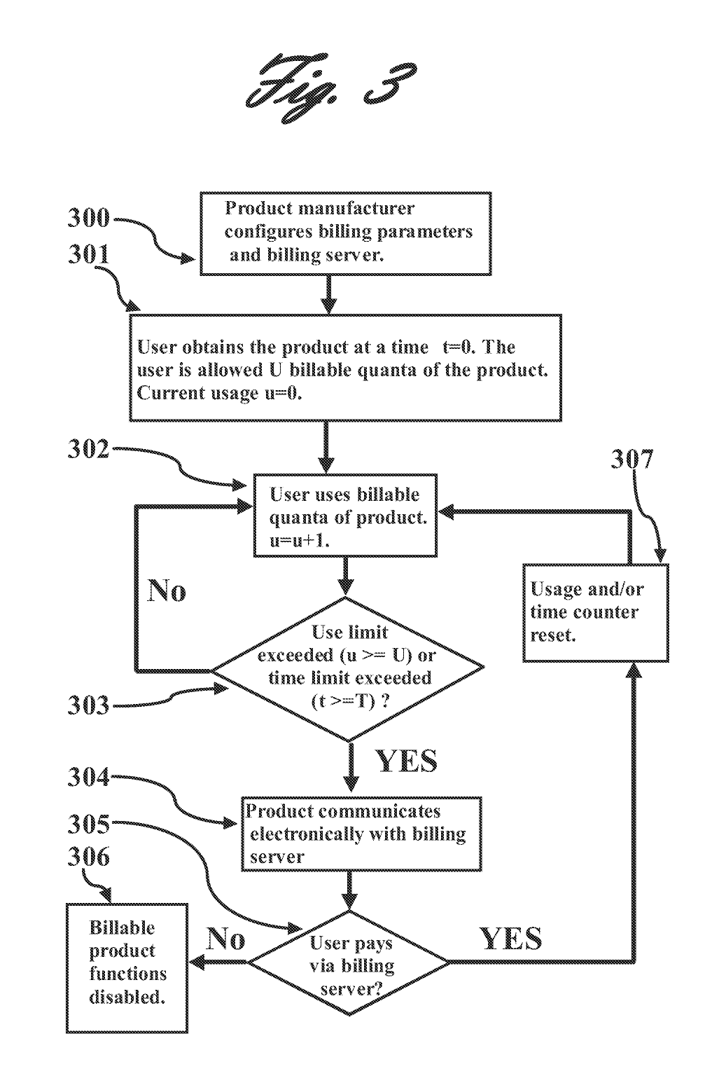

The second embodiment will be described in reference to FIG. 3. Thus, in this second embodiment, at step 300, the manufacturer chooses billing parameters and configures the product and billing server accordingly. At step 301 the user obtains the product and u and t are both set to 0. The user uses billable features of the product at step 302. After each use, at step 303, the use counter u is compared to the use limit U, and the time t is compared to the time limit T. If either of these limits are met or exceeded, then the product communicates electronically with the billing server, at step 304. Otherwise, the user may continue to use billable features of the product at step 302. If the user pays, as determined at step 305, then, at step 307, either one or both of the usage counter and the time counter are reset to 0, depending on whether the user purchased more use, or more time to use the uses already available, or both. If the user declines to pay, then, at step 306, the billable features are disabled, and will remain so until some time in the future when the user agrees to pay.

A third embodiment with multiple billing parts, and features generating billable quanta at different rates.

To point out that by the teaching of this invention, we are not limited to a two-part billing good, we consider for illustrative example a case in which both time-limited and use-limited parts may be purchased in “small” and “large” units. For example the large unit may cost proportionally less then an otherwise equivalent set of small units.

We will call the small and large use-limit U_{S}, and U_{L} respectively, and the small and large time limits T_{S} and T_{L} respectively.

To further illuminate the scope of the appended claims, in this third embodiment we will set the initial price to a non-zero value P₀, and require that the billing server be contacted to make this payment. The initial time T₀ at which t=0 will be set to the time that the user first uses the product for a billable or non-billable use. We could also have chosen some other time, such as the time the user first generates a billable quantum, or registers the product, or some other event. When the user makes the initial payment, they receive, for example, one small time-limited billing part and one small use-limited billing part.

For this third embodiment, we will again adopt the scheme used in the first embodiment for the relationship between time and use limits, namely, that after the initial payment, both time and use limits must be exceeded to require further billing, rather than either/or as in the case of the second embodiment. However, in this case, the user can purchase either or both of time and use counter resets, buy multiple packages of each at any given time, and be offered an array of price/quantity options. For instance, a bulk discount could be offered such that a large package of time, ten times greater than the small package, could be offered at only five times the price of the small package. A further discount could obtain for simultaneous purchase of time and use packages, etc. For illustrative purposes, time and use packages in this embodiment are cumulative. For instance, if at a given moment a user purchases one Tₛ limit and one T_{L} limit, then the effective limit is T=T_{S}+T_{L}+(any existing time credits). For non-limiting illustration, the use counter will be similarly generalized, so different functions of the product may generate billable quanta at different rates.

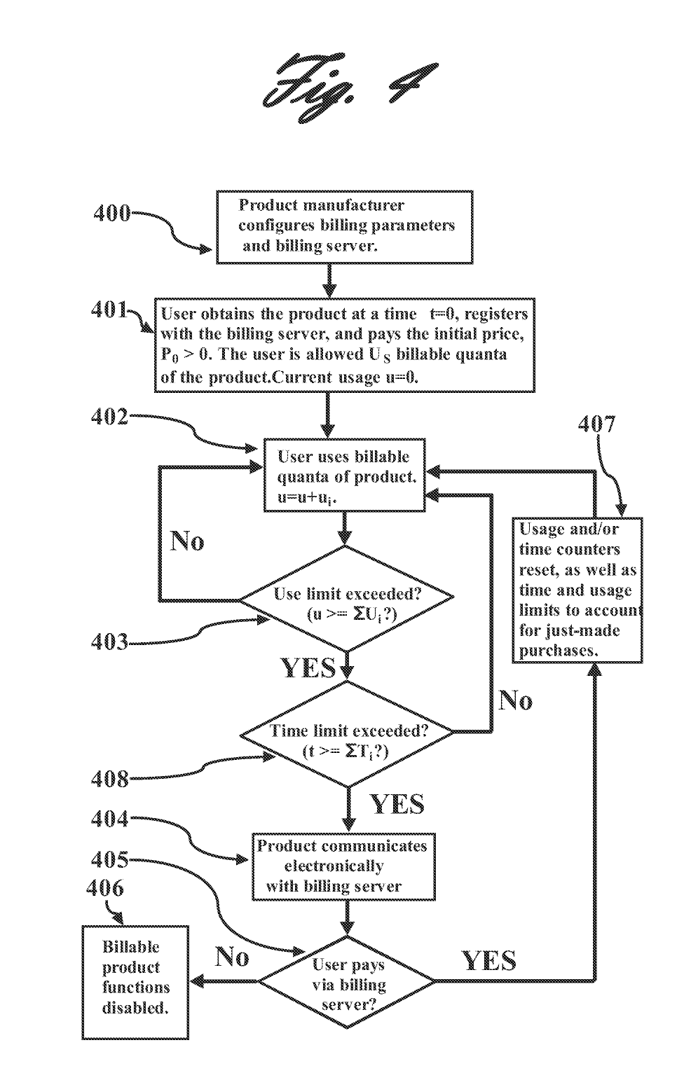

We will now review the operation of this third embodiment in reference to FIG. 4. At step 400, the product manufacturer (or service supplier) configures the billing parameters and billing server as described above. At this time, for instance, the initial values for the number of quanta generated by use of each billable use is determined. For example, in a product for sending email, sending an email with text could only generate one billable quantum, while sending an email with attachments could generate two billable quanta. The association of functions to number of quanta generated could, depending on implementation, be revisable at some later time. At step 401, The user obtains the product and sets up a relationship with the billing server, paying the initial price P₀ , With counters u and t set to 0, and initial use and time limits being Uₛ and Tₛ respectively. At step 402, the user uses the product, with the usage counter incremented by i units for use of the billable function i, according to the configuration set at step 400. At step 403, the usage u is compared to the sum of the currently active and paid for usage allotments, initially just U_{S}. If the cumulative active usage allotment is exceeded, then the current time counter is compared to the cumulative active time allotments at step 408, initially just T_{S}. If that cumulative time is exceeded, then, at step 404, the product communicates with the billing server, otherwise product usage may continue at step 402. The user may, at step 404, purchase one or more of each of a time allotment package or a use allotment package, each of these packages generally coming in difference sizes at different price points. If the user declines to purchase anything, then, at step 406, the billable functions of the product are disabled. If the user does pay, then time and usage counters, and time and usage limits are reset to account for the purchases. It should be clear throughout this disclosure, that time and use measurements are correctly measured each time they are needed for a decision process. If they are not, mechanisms must be implemented to make sure they are correct, or else the billing mechanism may fail. A fourth embodiment in which the billing good is physically embodied at least in part.

While the previous embodiments were described in terms of virtual (digital) billing goods, it may be advantageous to embody the billing goods in some physical tokens, e.g. as coins, smart cards, keys, or some other physical object. This may facilitate e.g. security, or third-party payment of the billing goods. For example, a company could distribute physical tokens which give their customers additional use or time to use of a digital good that the company wishes to promote. For the sake of illustrative concreteness, we will consider the case of a company that for a price P, and for a time T_{S} from a time T₀, distributes a fixed number Uₛ of streaming videos over the internet to a user during an unlimited time, but if U_{S} or more videos have already been streamed when T_{S} time elapses from T₀, then additional payment is required. This is a product billed by a mechanism within the scope of the first embodiment above. The company, as part of a promotion, may distribute a coupon by mail which may be redeemed extends T_{S} to T_{L}>T_{S} for users who have used U_{L}>U_{S} in time T_{S}. This promotion is designed to encourage users to use the streaming service more. Other promotions may be designed around extending U, or U and T, in some combination.

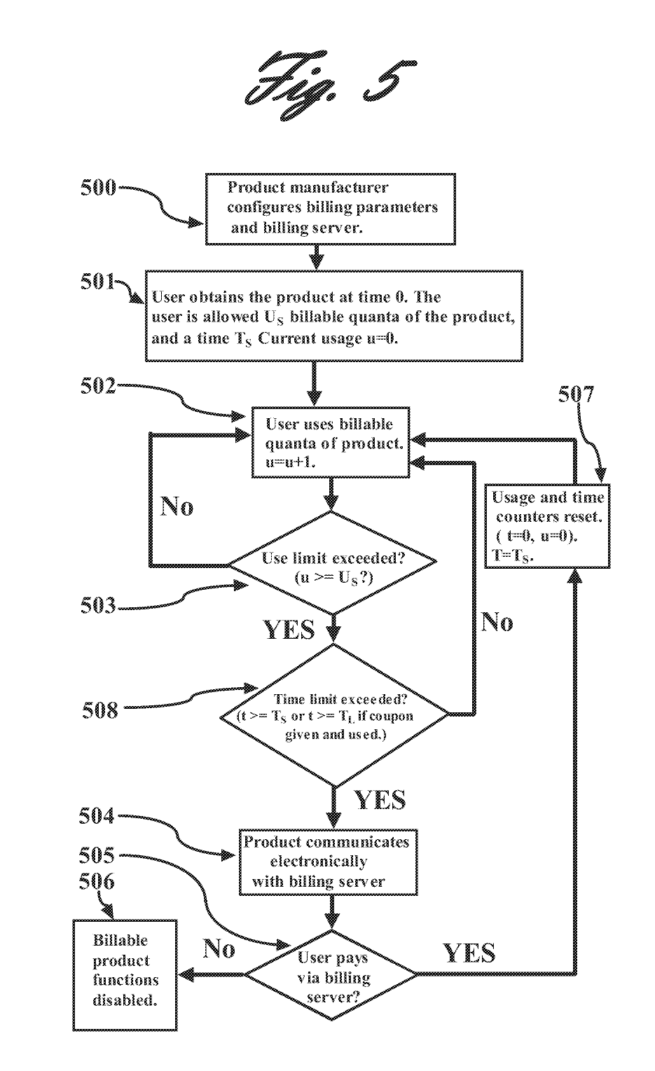

The operation of this embodiment will be described in reference to FIG. 5. At step 500 the company configures the billing server as described above. At step 501, the user obtains the product, meaning in this case, is set up to receive streaming videos from the company, having limits of U_{S} and T_{S} as described above. At step 502, the user uses billable quanta of the product, in this case, streams videos from the company. Then, at 503, the use is compared with the use limit U_{S}, at the same time (not shown) the usage is also compared with U_{L}, so that the company may determine whether to send a coupon to that user. At step 508, the time is compared to T_{L} or T_{S} depending on whether or not, respectively, the user has been given and used a coupon. If the applicable time limit has been exceeded, then the product (the video streamer in this example) communicates with the billing server at step 504. If the user pays at step 505, then the time and usage counters are reset, and the time limit is reset to T_{S}. Otherwise, streaming is disabled at step 506.

What is claimed is:

1. An apparatus for quantal billing of a digital product comprising
a) a billing server,
b) a digital product distribution mechanism which distributes units of said digital product to end users along with an associated
c) billing product, said billing product comprising
i) a usage counter, counting predefined quanta of usage, u, of said digital product, said quanta of usage accumulating when predefined billable functions of said digital product are used,
ii) a time counter, counting time, t, since a predefined event at t=0, and
iii) a mechanism to communicate with said billing server to negotiate billing in the event that said usage count u exceeds a predefined usage limit U, U>0, and/or said time count t exceeds a predefined time limit T, T>0, such that either or both of said usage count u and said time count t are reset to be less than said usage limit U and said time limit T respectively when billing is successfully negotiated, and said billable functions of said digital product are disabled otherwise.

2. The apparatus of claim 1, where when said digital product is initially distributed to a said end user via said digital product distribution mechanism, said usage count u has a value less than said usage limit U, U>0 and said time count t has a value less than said time limit T, T>0, whereby said apparatus permits usage of said digital product while u is less than U, regardless of whether said time count t is less than or greater than said time limit T, and said billing product negotiates said billing with said billing server only if both said usage count u is greater than said usage limit U and said time count t is greater than said time limit T.

3. The apparatus of claim 2 where when said end user uses said digital product sufficiently to cause said usage count u to exceed said usage limit U before said time count t exceeds said time limit T, then said user is notified that they may continue to use said digital product until a time such that said time limit t will equal said time limit T, without said billing.

4. The apparatus of claim 1, where when said digital product is initially distributed to said end users via said digital product distribution mechanism, said usage count u has a value less than said usage limit U, U>0, and said time count t has a value less than said time limit T, T>0, and where said billing server is contacted to negotiate said billing when either said use count u exceeds said use limit U or said time count t exceeds said time limit T and where upon successful negotiation of said billing with said billing server both of said usage counter u and said time counter t are reset to permit further usage of said digital product.

5. The apparatus of claim 1, where upon successful negotiation of billing, said billing server resets said usage counter u and/or said time counter t by an amount which is a function of the amount of payment, where said payment may be in currency or a currency substitute such as a coupon.
